(19) United States
(12) Patent Application Publication
(10) Pub. No.: US 2022/0344965 A1
(43) Pub. Date: Oct. 27, 2022

(54) ELECTRONIC DEVICE, ACCESSORY, METHOD AND PROGRAM FOR OPERATING ELECTRONIC DEVICE, AND METHOD AND PROGRAM FOR OPERATING ACCESSORY

(71) Applicant: FUJIFILM Corporation, Tokyo (JP)

(72) Inventors: Junichi SAITO, Saitama-shi (JP); Fuyuhiko MAEDA, Saitama-shi (JP)

(73) Assignee: FUJIFILM Corporation, Tokyo (JP)

(21) Appl. No.: 17/860,671

(22) Filed: Jul. 8, 2022

Related U.S. Application Data
(63) Continuation of application No. PCT/JP2021/005121, filed on Feb. 10, 2021.

(30) Foreign Application Priority Data
Feb. 19, 2020 (JP) 2020-026412

(51) Int. Cl. H02J 7/34; H01M 10/44; H02J 7/00

(52) U.S. Cl. CPC H02J 7/342; H01M 10/441; H02J 7/0013; H02J 7/00036; H02J 7/0048; H02J 7/0063; H02J 7/0068; H01M 2010/4278

(57) ABSTRACT

An accessory is attachable to and detachable from an electronic device, the accessory has at least one first battery that is charged with electric power supplied from an external power supply to the electronic device and a first processor that performs control to charge the first battery, the electronic device includes: a second battery that is charged with the electric power supplied from the external power supply; and a second processor that performs control to charge the first battery and the second battery, and the second processor has a communication part to communicate with the first processor.

### CROSS REFERENCE TO RELATED APPLICATION

This is a continuation of International Application No. PCT/JP2021/005121 filed on Feb. 10, 2021, and claims priority from Japanese Patent Application No. 2020-026412 filed on Feb. 19, 2020, the entire disclosures of which are incorporated herein by reference.

### BACKGROUND OF THE INVENTION

### 1. Field of the Invention

The present invention relates to an electronic device, an accessory attachable to and detachable from the electronic device, a method and a computer readable medium storing a program for operating the electronic device, and a method and a computer readable medium storing a program for operating the accessory.

### 2. Description of the Related Art

JP2005-295683A discloses a mobile terminal device in which a second battery is externally attached so that a battery life can be extended and the second battery can also be charged by using a charging circuit of a built-in battery. In the mobile terminal device having the charging circuit capable of being connected to a charging adapter and a power supply line that supplies power from the charging circuit to a regulator, a first switch connected between the power supply line and an output terminal of the built-in battery and a second switch connected between the power supply line and a battery connection terminal connected to an external battery are provided, and in a state in which the external battery is connected, only the first switch is controlled to be in an on state in a case where a voltage thereof is equal to or more than a predetermined reference voltage (a voltage value for giving a low voltage alert), only the second switch is controlled to be in an on state in a case where the voltage thereof is less than the reference voltage, and power is preferentially supplied from the external battery 5. Further, it is also possible to charge the external battery 5.

JP2019-086727A discloses an imaging device capable of charging a secondary battery, in which the imaging device can operate the secondary battery while charging the secondary battery. The imaging device includes a battery voltage comparison unit that compares remaining amounts of a plurality of secondary batteries, a supply time prediction unit that predicts suppliable times of the plurality of secondary batteries, and a target voltage setting unit that sets a target voltage of the secondary battery to be charged, from the suppliable times predicted by the supply time prediction unit and the remaining amounts of the plurality of secondary batteries detected by a battery voltage detection unit, in which one secondary battery is charged to a predetermined voltage, a target voltage of the other secondary battery to be charged is set from an operation mode selected by a user and the suppliable time of the one secondary battery which performs power supply, the other secondary battery is charged to the target voltage, power supply is switched to the imaging device and the charging of the one secondary battery is restarted after the charging of the other secondary battery to the target voltage is completed, and the plurality of secondary batteries are charged alternately.

### SUMMARY OF THE INVENTION

An object of the present invention is to provide an electronic device capable of reducing manufacturing costs and responding to an increase in the number of power supplies, an accessory attachable to and detachable from the electronic device, a method and a computer readable medium storing a program for operating the electronic device, and a method and a computer readable medium storing a program for operating the accessory.

According to one embodiment of the present invention, there is provided an electronic device to and from which an accessory is attachable and detachable, the accessory having at least one first battery that is charged with power supplied from an external power supply to the electronic device and a first processor that performs control to charge the first battery, the electronic device comprising: a second battery that is charged with the power supplied from the external power supply; and a second processor that performs control to charge the first battery and the second battery, in which the second processor has a communication part that is used to communicate with the first processor.

According to one embodiment of the present invention, there is provide an accessory that is attachable to and detachable from an electronic device, the accessory comprising: at least one first battery that is charged with power supplied from an external power supply to the electronic device; and a first processor that performs control to charge the first battery, in which the first processor has a communication part that is used to communicate with a second processor of the electronic device having a second battery and the second processor, the second battery being charged with the power supplied from the external power supply, the second processor performing control to charge the first battery and the second battery.

According to one embodiment of the present invention, there is provide a method for operating an electronic device to and from which an accessory is attachable and detachable, the accessory having at least one first battery that is charged with power supplied from an external power supply to the electronic device and a first processor that performs control to charge the first battery, the electronic device having a second battery that is charged with the power supplied from the external power supply, the method comprising: performing, by a second processor of the electronic device, control to charge the second battery and the first battery by transmitting and receiving charging control information necessary for performing control to charge the first battery to and from the first processor.

According to one embodiment of the present invention, there is provide a method for operating an accessory that is attachable to and detachable from an electronic device, the accessory having at least one first battery that is charged with power supplied from an external power supply to the electronic device and a first processor that performs control to charge the first battery, the method comprising: transmitting and receiving, by the first processor, charging control information necessary for performing control to charge the first battery to and from a second processor of the electronic device having a second battery and the second processor, the second battery being charged with the power supplied from the external power supply, the second processor performing control to charge the first battery and the second battery.

According to one embodiment of the present invention, there is provide a computer readable medium storing a program for operating an electronic device to and from which an accessory is attachable and detachable, the accessory having at least one first battery that is charged with power supplied from an external power supply to the electronic device and a first processor that performs control to charge the first battery, the electronic device having a second battery that is charged with the power supplied from the external power supply, the program causing a second processor of the electronic device to execute: a step of performing control to charge the second battery and the first battery by transmitting and receiving charging control information necessary for performing control to charge the first battery to and from the first processor.

According to one embodiment of the present invention, there is provide a computer readable medium storing a program for operating an accessory that is attachable to and detachable from an electronic device, the accessory having at least one first battery that is charged with power supplied from an external power supply to the electronic device and a first processor that performs control to charge the first battery, the program causing the first processor to execute: a step of transmitting and receiving charging control information necessary for performing control to charge the first battery to and from a second processor of the electronic device having a second battery and the second processor, the second battery being charged with the power supplied from the external power supply, the second processor performing control to charge the first battery and the second battery.

According to the embodiment of the present invention, it is possible to provide an electronic device capable of increasing usage time by responding to an increase in the number of power supplies while reducing manufacturing costs, an accessory attachable to and detachable from the electronic device, a method and a computer readable medium storing a program for operating the electronic device, and a method and a computer readable medium storing a program for operating the accessory.

### BRIEF DESCRIPTION OF THE DRAWINGS

FIG. 1 is a schematic diagram showing a schematic configuration of a camera system 100 including one embodiment of each of an electronic device and an accessory of an embodiment of the present invention.

FIG. 2 is a diagram showing a state in which an accessory 2 is attached to a digital camera 1 shown in FIG. 1.

FIG. 3 is a flowchart illustrating a charging operation performed in a state in which the accessory 2 is attached to the digital camera 1.

### DESCRIPTION OF THE PREFERRED EMBODIMENTS

Hereinafter, an embodiment of the present invention will be described with reference to the drawings.

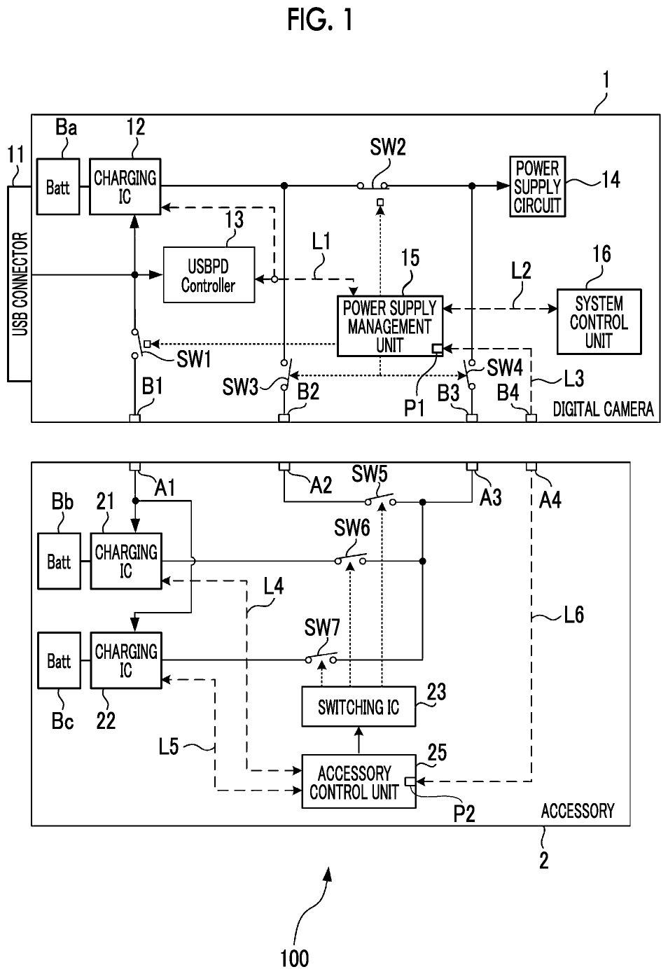

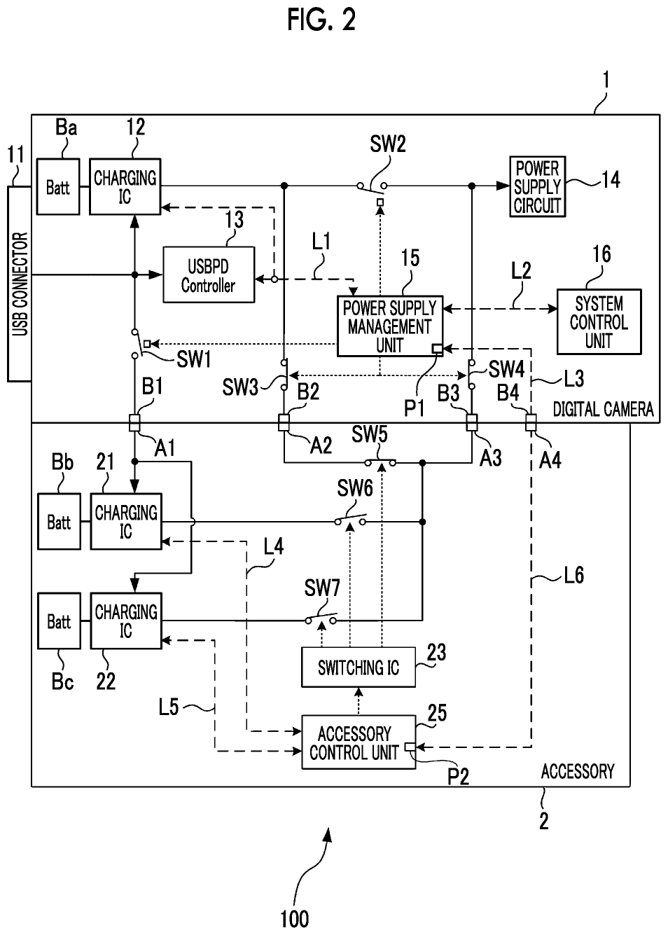

FIG. 1 is a schematic diagram showing a schematic configuration of a camera system 100 including one embodiment of each of an electronic device and an accessory of the embodiment of the present invention. The camera system 100 comprises a digital camera 1 that constitutes an electronic device, and an accessory 2 that is attachable to and detachable from the digital camera 1. FIG. 2 is a diagram showing a state in which the accessory 2 is attached to the digital camera 1 shown in FIG. 1.

The digital camera 1 is an imaging device including, for example, an imaging element (not shown), and an image processing circuit that processes an output signal of the imaging element to generate image data. The accessory 2 is a so-called external battery having a battery Bb and a battery Bc that are each formed of a chargeable secondary battery, such as a lithium ion battery.

The digital camera 1 comprises a USB connector 11 corresponding to the Universal Serial Bus Power Delivery (USBPD) standard, and a USBPD controller 13. The USB connector 11 is connected to an external power supply, such as an outlet or a mobile battery, via a USB cable (not shown).

The USBPD controller 13 is connected to the USB connector 11 and performs control so that power of up to 100 W can be fed to the digital camera 1 from the external power supply. Specifically, the USBPD controller 13 is formed of various processors, which will be described later. Hereinafter, the power supplied from the external power supply to the digital camera 1 via the USB connector 11 is also referred to as external power.

The digital camera 1 further comprises a battery Ba formed of a chargeable secondary battery, such as a lithium ion battery, a power supply circuit 14, a charging integrated circuit (IC) 12 which is a circuit that charges the battery Ba, that feeds power from the battery Ba to the power supply circuit 14, that feeds external power to the power supply circuit 14, and the like, a power supply management unit 15, a system control unit 16, switches SW1 to SW4 of which opening/closing is controlled by the power supply management unit 15, and terminals B1 to B4 that are used to perform electrical connection with the accessory 2. The switches SW1 to SW4 are each formed of a switching element, such as a transistor.

The switch SW1 is connected to the USB connector 11 and the terminal B1. The USB connector 11 and the terminal B1 are electrically connected to each other, and external power can be supplied to the charging IC 12 and the terminal B1, in a state in which the switch SW1 is closed. The USB connector 11 and the terminal B1 are electrically cut off from each other, and external power can be supplied only to the charging IC 12, in a state shown in FIG. 1 in which the switch SW1 is open.

The switch SW2 is connected to the charging IC 12 and the power supply circuit 14. The switch SW3 is connected to the terminal B2 and a connection point between the charging IC 12 and the switch SW2. The switch SW4 is connected to the terminal B3 and a connection point between the switch SW2 and the power supply circuit 14.

In a state in which the switch SW2 is closed and the switch SW3 and the switch SW4 are each open, the charging IC 12 and the power supply circuit 14 are electrically connected to each other, and the voltage of the battery Ba can be supplied to the power supply circuit 14.

The power supply circuit 14 generates a power supply voltage for operating various types of hardware, such as the USBPD controller 13, the power supply management unit 15, the system control unit 16, the imaging element, and the image processing circuit in the digital camera 1, and supplies the power supply voltage to the various types of hardware. The power supply circuit 14 is configured to generate the power supply voltage from each of the voltage of the battery Ba, the external power, the voltage of the battery Bb of the accessory 2, and the voltage of the battery Bc of the accessory 2.

The power supply management unit 15 performs power supply management including the control to charge the battery Ba, the control to charge the battery Bb and the battery Bc of the accessory 2, and the control to feed power from each of these batteries to the power supply circuit 14. The power supply management unit 15 is formed of various processors, which will be described later.

The power supply management unit 15 is configured to communicate with the USBPD controller 13 and the charging IC 12 via a communication line L1. The power supply management unit 15 is configured to communicate with the system control unit 16 via a communication line L2. The power supply management unit 15 is configured to acquire information regarding the voltage of the battery Ba from the charging IC 12 via the communication line L1. The power supply management unit 15 is configured to acquire information regarding external power from the USBPD controller 13 via the communication line L1.

The power supply management unit 15 is provided with a terminal P1 constituting a communication part that is used to communicate with an accessory control unit 25, which will be described later, in the accessory 2. The terminal P1 is connected to the terminal B4 via a communication line L3. The power supply management unit 15 performs control to close the switch SW2 and open the switch SW1, the switch SW3, and the switch SW4, in a state in which the accessory 2 is not attached to the digital camera 1. The power supply management unit 15 performs control to open the switch SW2 and close the switch SW3 and the switch SW4, in a state in which the accessory 2 is attached to the digital camera 1. The power supply management unit 15 switches the open/closed state of the switch SW1 depending on the situation, in a state in which the accessory 2 is attached to the digital camera 1.

In a case where an external power supply is connected to the USB connector 11 in the state of FIG. 1 in which the accessory 2 is not attached to the digital camera 1, external power is determined by the USBPD controller 13, and the power supply management unit 15 decides charging power which is used to charge the battery Ba, according to the magnitude of the determined external power. Then, the power supply management unit 15 controls the charging IC 12 and starts charging the battery Ba with the decided charging power.

The system control unit 16 is formed of various processors, which will be described later. The system control unit 16 controls the entire digital camera 1 in an integrated manner, and specifically, is formed of a processor having a higher processing capacity than that of the power supply management unit 15.

The accessory 2 comprises the battery Bb, a charging IC 21 which is a circuit that charges the battery Bb and that feeds power from the battery Bb to the power supply circuit 14, the battery Bc, a charging IC 22 which is a circuit that charges the battery Bc and that feeds power from the battery Bc to the power supply circuit 14, switches SW5 to SW7, a switching IC 23 that performs control to open/close each of the switches SW5 to SW7, the accessory control unit 25, and terminals A1 to A4 that are used to perform electrical connection with the digital camera 1. The switches SW5 to SW7 are each formed of a switching element, such as a transistor.

As shown in FIG. 2, the terminal A1 and the terminal B1 are electrically connected to each other, the terminal A2 and the terminal B2 are electrically connected to each other, the terminal A3 and the terminal B3 are electrically connected to each other, and the terminal A4 and the terminal B4 are electrically connected to each other, in a state in which the accessory 2 is attached to the digital camera 1.

The charging IC 21 and the charging IC 22 are connected in parallel to the terminal A1. The external power supplied to the digital camera 1 can be supplied not only to the charging IC 12 but also to the charging IC 21 and the charging IC 22 of the accessory 2, in a state in which the accessory 2 is attached to the digital camera 1 and the switch SW1 of the digital camera 1 is closed.

The switch SW5 is connected to the terminal A2 and the terminal A3. The switch SW6 is connected to the charging IC 21 and a connection point between the switch SW5 and the terminal A3. The switch SW7 is connected to the charging IC 22 and a connection point between the switch SW5 and the terminal A3.

The terminal A2 and the terminal A3 are electrically connected to each other, and the charging IC 21 and the charging IC 22 are electrically cut off from the terminal A3, in a state in which the switch SW5 is closed and the switch SW6 and the switch SW7 are open. The charging IC 21 and the terminal A3 are electrically connected to each other, and the terminal A2 and the charging IC 22 are electrically cut off from the terminal A3, in a state in which the switch SW6 is closed and the switch SW5 and the switch SW7 are open. The charging IC 22 and the terminal A3 are electrically connected to each other, and the terminal A2 and the charging IC 21 are electrically cut off from the terminal A3, in a state in which the switch SW7 is closed and the switch SW5 and the switch SW6 are open.

As shown in FIG. 2, in a case where the accessory 2 is attached to the digital camera 1, the power supply management unit 15 of the digital camera 1 opens the switch SW2 and closes the switch SW3 and the switch SW4. Therefore, in this state, in a case where only the switch SW5, out of the switches SW5 to SW7, is closed in the accessory 2, the voltage of the battery Ba of the digital camera 1 can be supplied to the power supply circuit 14 of the digital camera 1. Further, in this state, in a case where only the switch SW6, out of the switches SW5 to SW7, is closed in the accessory 2, the voltage of the battery Bb of the accessory 2 can be supplied to the power supply circuit 14 of the digital camera 1. Further, in this state, in a case where only the switch SW7, out of the switches SW5 to SW7, is closed in the accessory 2, the voltage of the battery Bc of the accessory 2 can be supplied to the power supply circuit 14 of the digital camera 1.

The switching IC 23 can supply the voltage to the power supply circuit 14 from any one of the battery Ba, the battery Bb, or the battery Bc by closing only one of the switches SW5 to SW7 in accordance with the control performed by the accessory control unit 25.

The accessory control unit 25 performs the power supply management for the accessory 2 including the control to charge the battery Bb and the battery Bc and the control to feed power from each of these batteries to the power supply circuit 14. The accessory control unit 25 is formed of various processors, which will be described later.

The accessory control unit 25 is configured to communicate with the charging IC 21 via a communication line L4. The accessory control unit 25 is configured to communicate with the charging IC 22 via a communication line L5. The accessory control unit 25 is configured to acquire information regarding the voltage of the battery Bb from the charging IC 21 via the communication line L4. The accessory control unit 25 is configured to acquire information regarding the voltage of the battery Bc from the charging IC 22 via the communication line L5.

The accessory control unit 25 determines whether or not the battery Bb is chargeable, on the basis of the information regarding the voltage of the battery Bb. Specifically, the accessory control unit 25 determines that the battery Bb is not chargeable in a case where the voltage of the battery Bb is a threshold value or more, and determines that the battery Bb is chargeable in a case where the voltage of the battery Bb is less than the threshold value.

The accessory control unit 25 determines whether or not the battery Bc is chargeable on the basis of the information regarding the voltage of the battery Bc. Specifically, the accessory control unit 25 determines that the battery Bc is not chargeable in a case where the voltage of the battery Bc is a threshold value or more, and determines that the battery Bc is chargeable in a case where the voltage of the battery Bc is less than the threshold value.

The accessory control unit 25 is provided with a terminal P2 that constitutes a communication part that is used to communicate with the power supply management unit 15 of the digital camera 1. The terminal P2 is connected to the terminal A4 via a communication line L6. As shown in FIG. 2, the terminal P2 of the accessory control unit 25 and the terminal P1 of the power supply management unit 15 are connected to each other via the communication line L6, the terminal A4, the terminal B4, and the communication line L3, in a state in which the accessory 2 is attached to the digital camera 1.

The accessory control unit 25 generates the above-mentioned information indicating whether or not the battery Bb is chargeable and the above-mentioned information indicating whether or not the battery Bc is chargeable, as first charging control information, and transmits the first charging control information from the terminal P2 to the power supply management unit 15. Further, in a case where the accessory control unit 25 acquires second charging control information transmitted from the terminal P1 of the power supply management unit 15 and received to the terminal P2, the accessory control unit 25 performs control to charge at least one of the battery Bb or the battery Bc on the basis of the second charging control information.

The second charging control information includes information for a battery Bb including information for giving an instruction to start charging the battery Bb and information for designating charging power to be supplied to the battery Bb, and information for a battery Bc including information for giving an instruction to start charging the battery Bc and information for designating charging power to be supplied to the battery Bc. The first charging control information and the second charging control information constitute charging control information necessary for performing control to charge the battery Bb and the battery Bc.

The above-mentioned various processors include, for example, a central processing unit (CPU) which is a general-purpose processor that executes software (programs) to function as various processing units, a programmable logic device (PLD), such as a field programmable gate array (FPGA), which is a processor having a changeable circuit configuration after manufacture, a dedicated electric circuit, such as an application specific integrated circuit (ASIC), which is a processor having a dedicated circuit configuration designed to execute specific processing.

The power supply management unit 15, the USBPD controller 13, the system control unit 16, and the accessory control unit 25 may be each formed of one of the various processors, or a combination of two or more processors of the same type or different types (For example, a plurality of FPGAs or a combination of a CPU and an FPGA). Further, for example, the power supply management unit 15 and the USBPD controller 13 may be formed of one processor. More specifically, the hardware structure of these various processors is an electric circuit (circuitry) in which circuit elements, such as semiconductor elements, are combined.

(Operation of Camera System 100)

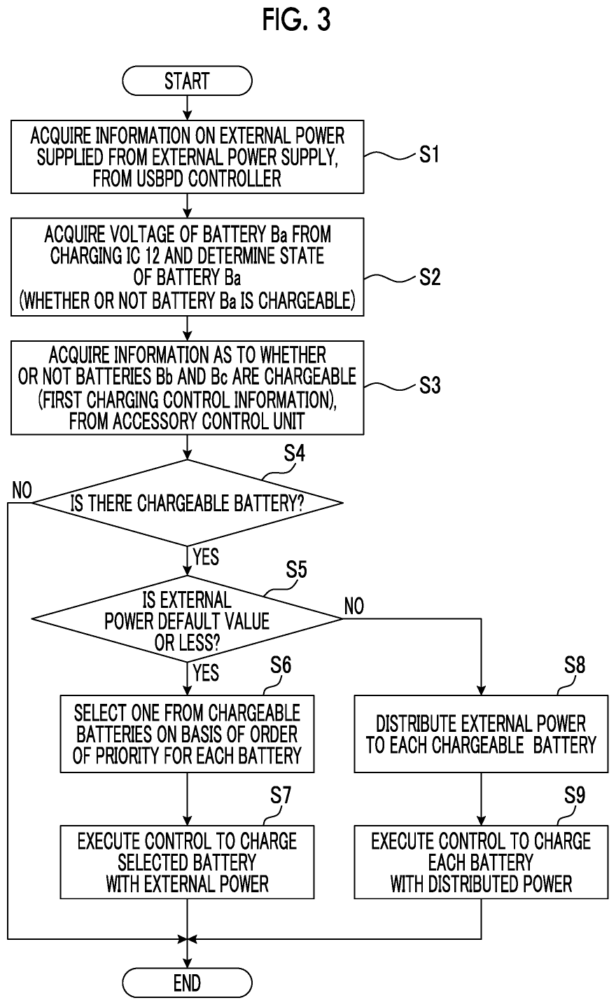

In the camera system 100 configured as described above, a charging operation in a state in which the accessory 2 is attached to the digital camera 1 will be described. FIG. 3 is a flowchart illustrating the charging operation in a state in which the accessory 2 is attached to the digital camera 1.

In a case where the external power supply is connected to the USB connector 11 in a state in which the accessory 2 is attached to the digital camera 1, the power supply management unit 15 of the digital camera 1 acquires information on the external power supplied from the external power supply, from the USBPD controller 13 (step S1).

Further, the power supply management unit 15 acquires information on the voltage of the battery Ba from the charging IC 12, and determines the state of the battery Ba (state of whether or not the battery Ba is chargeable) on the basis of this information (step S2). Specifically, the power supply management unit 15 determines that the battery Ba is not chargeable in a case where the voltage of the battery Ba is a threshold value or more, and determines that the battery Ba is chargeable in a case where the voltage of the battery Ba is less than the threshold value.

Further, the power supply management unit 15 acquires the first charging control information indicating the state of the battery Bb and the state of the battery Bc (state of whether or not the battery Bb and the battery Bc are chargeable), from the accessory control unit 25 (step S3).

In a case where the power supply management unit 15 determines that there is no chargeable battery, out of the battery Ba, the battery Bb, and the battery Bc, on the basis of the result of the processing in step S2 and the first charging control information acquired in step S3 (step S4: NO), the charging operation ends.

In a case where the power supply management unit 15 determines that there is a chargeable battery, out of the battery Ba, the battery Bb, and the battery Bc, (step S4: YES), the power supply management unit 15 determines whether or not the external power acquired in step S1 is a default value or less (step S5). The processing of step S5 is performed in order to determine whether the external power has a value sufficient to charge a plurality of batteries. Although the default value is decided to be an appropriate value according to the system, 7.5 W is used as an example.

In a case where the external power is the default value or less (step S5: YES), the power supply management unit 15 selects one out of the battery Ba, the battery Bb, and the battery Bc, as the battery to be charged (Step S6). A memory of the power supply management unit 15 stores information on the priority of charging in association with each of the battery Ba, the battery Bb, and the battery Bc.

In a case where a plurality of batteries, out of the battery Ba, the battery Bb, and the battery Bc, are chargeable, the power supply management unit 15 selects one out of the plurality of batteries on the basis of this priority. The priority is set to, for example, “high” for the battery Ba, “medium” for the battery Bb, and “low” for the battery Bc. The power supply management unit 15 preferentially selects a battery having high priority.

For example, in a case where the plurality of batteries including the battery Ba, out of the battery Ba, the battery Bb, and the battery Bc, are chargeable, the power supply management unit 15 selects the battery Ba having the highest priority in step S6. In a case where the battery Bb and the battery Bc, out of the battery Ba, the battery Bb, and the battery Bc, are chargeable, the power supply management unit 15 selects the battery Bb having relatively high priority in step S6. In a case where only one battery, out of the battery Ba, the battery Bb, and the battery Bc, is chargeable, the power supply management unit 15 selects the one battery in step S6 regardless of the priority.

The power supply management unit 15 selects one battery in step S6, and then executes control to charge the selected battery (step S7). Specifically, the power supply management unit 15 first decides charging power Px which is used to charge the selected battery, on the basis of the external power. For example, the power supply management unit 15 decides all of the external power as the charging power Px, or decides a part of the external power (for example, 80%) as the charging power Px.

In a case where the battery Ba is selected in step S6, the power supply management unit 15 controls the switch SW1 to be in an open state and instructs the charging IC 12 to charge the battery Ba with the charging power Px. In response to this instruction, the charging IC 12 charges the battery Ba with the charging power Px designated by the power supply management unit 15.

In a case where the battery Bb (or the battery Bc) is selected in step S6, the power supply management unit 15 performs control to close the switch SW1, and transmits the second charging control information including information on the charging power Px and information for giving an instruction to start charging the battery Bb (or the battery Bc), to the accessory control unit 25. The accessory control unit 25 performs control to charge the battery Bb (or the battery Bc) on the basis of the second charging control information.

Specifically, the accessory control unit 25 instructs the charging IC 21 (or the charging IC 22) to charge the battery Bb (or the battery Bc) with the charging power Px designated in the second charging control information. In response to this instruction, the charging IC 21 (or the charging IC 22) charges the battery Bb (or the battery Bc) with the charging power Px designated by the power supply management unit 15.

In a case where the external power exceeds the default value in step S5 (step S5: NO), the power supply management unit 15 distributes the external power to each chargeable battery, out of the battery Ba, the battery Bb, and the battery Bc, to decide charging power Py of each battery (step S8). It is desirable to provide an upper limit value for the charging power Py. Hereinafter, a detailed example of step S8 will be described for each number of chargeable batteries.

<In Case of One Chargeable Battery>

The power supply management unit 15 decides all of the external power as the charging power Py, or decides a part of the external power (for example, 80%) as the charging power Py.

<In Case of Two Chargeable Batteries>

The power supply management unit 15 decides a value obtained by dividing all of the external power into two equal parts as the charging power Py, or decides a value obtained by dividing a part of the external power (for example, 80%) into two equal parts as the charging power Py. Here, the charging power Py to be distributed to each of the two batteries is set to the same value, but the charging power Py to be distributed may be different for each battery.

<In Case of Three Chargeable Batteries>

The power supply management unit 15 decides a value obtained by dividing all of the external power into three equal parts as the charging power Py, or decides a value obtained by dividing a part of the external power (for example, 80%) into three equal parts as the charging power Py. Here, the charging power Py to be distributed to each of the three batteries is set to the same value, but the charging power Py to be distributed may be different for each battery. It is desirable to decide such charging power Py in accordance with a table stored in the memory of the power supply management unit 15 (a table in which the external power is associated with the charging power Py for each number of batteries). With this, the cost of the power supply management unit 15 can be reduced.

After step S8, the power supply management unit 15 executes control to charge each chargeable battery with the charging power Py (step S9). Hereinafter, the details of step S9 will be described for each combination of chargeable batteries.

<In Case Where Only Battery Ba Is Chargeable>

The power supply management unit 15 controls the switch SW1 to be in an open state, and instructs the charging IC 12 to charge the battery Ba with the charging power Py. In response to this instruction, the charging IC 12 charges the battery Ba with the charging power Py designated by the power supply management unit 15.

<In Case Where Only Battery Bb (or Battery Bc) Is Chargeable>

The power supply management unit 15 performs control to close the switch SW1 and transmits the second charging control information including information on the charging power Py and information for giving an instruction to charge the battery Bb (or the battery Bc), to the accessory control unit 25. The accessory control unit 25 performs control to charge the battery Bb (or the battery Bc) on the basis of the second charging control information.

Specifically, the accessory control unit 25 instructs the charging IC 21 (or the charging IC 22) to charge the battery Bb (or the battery Bc) with the charging power Py designated in the second charging control information. In response to this instruction, the charging IC 21 (or the charging IC 22) charges the battery Bb (or the battery Bc) with the charging power Py designated by the power supply management unit 15.

<In Case Where Only Battery Bb and Battery Bc Are Chargeable>

The power supply management unit 15 performs control to close the switch SW1 and transmits the second charging control information including the information on the charging power Py and information for giving an instruction to charge the battery Bb and the battery Bc, to the accessory control unit 25. The accessory control unit 25 performs control to charge the battery Bb and the battery Bc on the basis of the second charging control information.

Specifically, the accessory control unit 25 instructs the charging IC 21 and the charging IC 22 to charge the battery Bb and the battery Bc with the charging power Py designated in the second charging control information, respectively. In response to this instruction, the charging IC 21 charges the battery Bb with the charging power Py designated by the power supply management unit 15. Further, the charging IC 22 charges the battery Bc with the charging power Py designated by the power supply management unit 15.

<In Case Where Only Battery Ba and Battery Bb (or Battery Bc) Are Chargeable>

The power supply management unit 15 performs control to close the switch SW1, and instructs the charging IC 12 to charge the battery Ba with the charging power Py. In response to this instruction, the charging IC 12 charges the battery Ba with the charging power Py designated by the power supply management unit 15.

Further, the power supply management unit 15 transmits the second charging control information including the information on the charging power Py and the information for giving an instruction to charge the battery Bb (or the battery Bc), to the accessory control unit 25. The accessory control unit 25 performs control to charge the battery Bb (or the battery Bc) on the basis of the second charging control information.

Specifically, the accessory control unit 25 instructs the charging IC 21 (or the charging IC 22) to charge the battery Bb (or the battery Bc) with the charging power Py designated in the second charging control information. In response to this instruction, the charging IC 21 (or the charging IC 22) charges the battery Bb (or the battery Bc) with the charging power Py designated by the power supply management unit 15.

<In Case Where Battery Ba, Battery Bb, and Battery Bc Are Chargeable>

The power supply management unit 15 performs control to close the switch SW1, and instructs the charging IC 12 to charge the battery Ba with the charging power Py. In response to this instruction, the charging IC 12 charges the battery Ba with the charging power Py designated by the power supply management unit 15.

Further, the power supply management unit 15 transmits the second charging control information including the information on the charging power Py and the information for giving an instruction to charge the battery Bb and the battery Bc, to the accessory control unit 25. The accessory control unit 25 performs control to charge the battery Bb and the battery Bc on the basis of the second charging control information.

Specifically, the accessory control unit 25 instructs the charging IC 21 and the charging IC 22 to charge the battery Bb and the battery Bc with the charging power Py designated in the second charging control information, respectively. In response to this instruction, the charging IC 21 charges the battery Bb with the charging power Py designated by the power supply management unit 15. Further, the charging IC 22 charges the battery Bc with the charging power Py designated by the power supply management unit 15.

(Effect of Camera System 100)

In the camera system 100, the accessory control unit 25 and the power supply management unit 15 are configured to communicate with each other via the communication parts (terminal P2 and terminal P1). Therefore, as described above, the power supply management unit 15 can acquire the first charging control information regarding the states of the batteries Bb and Bc from the accessory control unit 25, and can perform control to charge the batteries Ba, Bb, and Bc on the basis of the second charging control information. Further, the control to charge the batteries Bb and Bc can be performed by the accessory control unit 25 in accordance with the control performed by the power supply management unit 15. With this, it is not necessary to use a unit having a large memory or a high capacity as the power supply management unit 15, so that it is possible to reduce the manufacturing costs of the digital camera 1. Further, since the battery Ba, and the batteries Bb and Bc are controlled to be charged by separate processors, charging can be efficiently performed.

Further, in the camera system 100, the power supply management unit 15 decides the charging power to be supplied to each of the batteries Ba, Bb, and Bc on the basis of the external power, the state of the battery Ba, and the states of the batteries Bb and Bc based on the first charging control information received from the accessory control unit 25, and performs control to charge each of the batteries Ba, Bb, and Bc on the basis of the charging power. In this way, it is possible to perform flexible charging control by changing the number of batteries to be charged depending on the situation of the external power. Further, the charging efficiency can be enhanced.

Further, with the camera system 100, the accessory control unit 25 need only determine whether or not the batteries Bb and Bc are chargeable and perform control to charge the batteries Bb and Bc in accordance with the control performed by the power supply management unit 15 during the charging operation. Therefore, it is not necessary to use a unit having a high processing capacity or a memory as the accessory control unit 25, and the cost of the accessory 2 can be reduced.

In the above camera system 100, a configuration is adopted in which the accessory 2 has two batteries, but the number of batteries provided in the accessory 2 is not limited thereto and may be one, or three or more. Although a digital camera is used as an example of the electronic device, another electronic device, such as a smartphone, may be used.

The camera system 100 may perform communication between the power supply management unit 15 and the accessory control unit 25 with wireless communication, instead of wired communication via the terminal B4 and the terminal A4. For example, a configuration may be adopted in which each of the terminal B4 and the terminal A4 is replaced with an interface that is used to perform short-range wireless communication and the respective interfaces are connected to the terminal P1 and the terminal P2. In this configuration, each interface and the terminal connected to the interface constitute a communication part. For example, wireless LAN, Bluetooth (registered trademark), infrared communication (Infrared Data Association: IrDA) (registered trademark), Ultra Wideband (UWB) (registered trademark), and ZigBee (registered trademark) can be used as methods of the wireless communication. In a case where wireless communication is used, it is possible to avoid communication failure due to, for example, poor contact between terminals in wired communication, and a method capable of higher speed communication is easily selected as necessary.

As described above, at least the following matters are described in the present specification. It should be noted that the constituent elements and the like corresponding to the above-described embodiment are shown in parentheses, but the present invention is not limited thereto.

(1)

An electronic device to and from which an accessory (accessory 2) is attachable and detachable, the accessory having at least one first battery (battery Bb and battery Bc) that is charged with power supplied from an external power supply to the electronic device and a first processor (accessory control unit 25) that performs control to charge the first battery, the electronic device (digital camera 1) comprising:

a second battery (battery Ba) that is charged with the power supplied from the external power supply; and

a second processor (power supply management unit 15) that performs control to charge the first battery and the second battery, in which the second processor has a communication part (terminal P1) that is used to communicate with the first processor.

(2)

The electronic device according to (1),

in which the second processor transmits and receives charging control information necessary for performing control to charge the first battery to and from the first processor via the communication part.

(3)

The electronic device according to (2),

in which the second processor decides charging power to be supplied to each of the first battery and the second battery on the basis of the power supplied from the external power supply, a state of the second battery, and a state of the first battery based on the charging control information (first charging control information) received from the communication part, and performs control to charge the first battery and the second battery on the basis of the charging power.

(4)

The electronic device according to (3),

in which the second processor transmits, to the first processor, information on the charging power to be supplied to the first battery and information for giving an instruction to charge the first battery, as the charging control information (second charging control information), and causes the first processor to perform control to charge the first battery on the basis of the charging control information.

(5)

The electronic device according to (3) or (4),

in which the second processor performs control to supply the power supplied from the external power supply to any one of the first battery or the second battery in accordance with a priority associated with each of the first battery and the second battery, in a state in which there are a plurality of chargeable batteries based on the state of the first battery and the state of the second battery and the power supplied from the external power supply is a default value or less.

(6)

The electronic device according to any one of (3) to (5),

in which the second processor performs control to supply the power supplied from the external power supply to a chargeable battery based on the state of the first battery and the state of the second battery, out of the first battery and the second battery, in a state in which the power supplied from the external power supply exceeds a default value.

(7)

The electronic device according to any one of (2) to (6),

in which the second processor receives the charging control information (first charging control information) including information indicating whether or not charging is possible for each first battery, from the first processor, and transmits the charging control information (second charging control information) including information for giving an instruction to start charging for each first battery and information on charging power which is used for the charging, to the first processor.

(8)

The electronic device according to any one of (1) to (7), further comprising:

an imaging element that is operated by any one of the power of the external power supply, power of the first battery, or power of the second battery.

(9)

An accessory (accessory 2) that is attachable to and detachable from an electronic device (digital camera 1), the accessory comprising:

at least one first battery (battery Bb and battery Bc) that is charged with power supplied from an external power supply to the electronic device; and

a first processor (accessory control unit 25) that performs control to charge the first battery,

in which the first processor has a communication part (terminal P2) that is used to communicate with a second processor (power supply management unit 15) of the electronic device having a second battery (battery Ba) and the second processor, the second battery being charged with the power supplied from the external power supply, the second processor performing control to charge the first battery and the second battery.

(10)

The accessory according to (9), in which the first processor transmits and receives charging control information necessary for performing control to charge the first battery to and from the second processor via the communication part.

(11)

The accessory according to (10), in which the charging control information (first charging control information) transmitted by the first processor to the second processor includes information indicating whether or not charging is possible for each first battery,

the charging control information (second charging control information) received by the first processor from the second processor includes information for giving an instruction to start charging for each first battery and information indicating charging power which is used for the charging, and

the first processor performs control to charge the first battery on the basis of the charging control information received from the second processor.

(12)

The accessory according to any one of (9) to (11), in which the electronic device is an imaging device.

(13)

A method for operating an electronic device (digital camera 1) to and from which an accessory (accessory 2) is attachable and detachable, the accessory having at least one first battery (battery Bb and battery Bc) that is charged with power supplied from an external power supply to the electronic device and a first processor (accessory control unit 25) that performs control to charge the first battery, the electronic device having a second battery (battery Ba) that is charged with the power supplied from the external power supply, the method comprising:

performing, by a second processor (power supply management unit 15) of the electronic device, control to charge the second battery and the first battery by transmitting and receiving charging control information necessary for performing control to charge the first battery to and from the first processor.

(14)

The method for operating an electronic device according to (13), in which the second processor decides charging power to be supplied to each of the first battery and the second battery on the basis of the power supplied from the external power supply, a state of the second battery, and a state of the first battery based on the charging control information (first charging control information) received from the first processor, and performs control to charge the first battery and the second battery on the basis of the charging power.

(15)

The method for operating an electronic device according to (14),

in which the second processor transmits, to the first processor, information on the charging power to be supplied to the first battery and information for giving an instruction to charge the first battery, as the charging control information (second charging control information), and causes the first processor to perform control to charge the first battery on the basis of the charging control information.

(16)

The method for operating an electronic device according to (14) or (15),

in which the second processor performs control to supply the power supplied from the external power supply to any one of the first battery or the second battery in accordance with priority associated with each of the first battery and the second battery, in a state in which there are a plurality of chargeable batteries based on the state of the first battery and the state of the second battery and the power supplied from the external power supply is a default value or less.

(17)

The method for operating an electronic device according to any one of (14) to (16),

in which the second processor performs control to supply the power supplied from the external power supply to a chargeable battery based on the state of the first battery and the state of the second battery, out of the first battery and the second battery, in a state in which the power supplied from the external power supply exceeds a default value.

(18)

The method for operating an electronic device according to any one of (13) to (17),

in which the second processor receives the charging control information (first charging control information) including information indicating whether or not charging is possible for each first battery, from the first processor, and transmits the charging control information (second charging control information) including information for giving an instruction to start charging for each first battery and information on charging power which is used for the charging, to the first processor.

(19)

The method for operating an electronic device according to any one of (13) to (18),

in which the electronic device is provided with an imaging element that is operated by any one of the power of the external power supply, power of the first battery, or power of the second battery.

(20)

A method for operating an accessory (accessory 2) that is attachable to and detachable from an electronic device (digital camera 1), the accessory having at least one first battery (battery Bb and battery Bc) that is charged with power supplied from an external power supply to the electronic device and a first processor (accessory control unit 25) that performs control to charge the first battery, the method comprising:

transmitting and receiving, by the first processor, charging control information necessary for performing control to charge the first battery to and from a second processor (power supply management unit 15) of the electronic device having a second battery and the second processor, the second battery (battery Ba) being charged with the power supplied from the external power supply, the second processor performing control to charge the first battery and the second battery.

(21)

The method for operating an accessory according to (20),

in which the first processor transmits the charging control information (first charging control information) including information indicating whether or not charging is possible for each first battery, to the second processor,

the first processor receives the charging control information (second charging control information) including information for giving an instruction to start charging for each first battery and information indicating charging power which is used for the charging, from the second processor, and

the first processor performs control to charge the first battery on the basis of the charging control information received from the second processor.

(22)

The method for operating an accessory according to (20) or (21),

in which the electronic device is an imaging device.

(23)

A program for operating an electronic device (digital camera 1) to and from which an accessory (accessory 2) is attachable and detachable, the accessory having at least one first battery (battery Bb and battery Bc) that is charged with power supplied from an external power supply to the electronic device and a first processor (accessory control unit 25) that performs control to charge the first battery, the electronic device having a second battery (battery Ba) that is charged with the power supplied from the external power supply, the program causing a second processor (power supply management unit 15) of the electronic device to execute:

a step of performing control to charge the second battery and the first battery by transmitting and receiving charging control information necessary for performing control to charge the first battery to and from the first processor.

(24)

A program for operating an accessory (accessory 2) that is attachable to and detachable from an electronic device (digital camera 1), the accessory having at least one first battery (battery Bb and battery Bc) that is charged with power supplied from an external power supply to the electronic device and a first processor (accessory control unit 25) that performs control to charge the first battery, the program causing the first processor to execute:

a step of transmitting and receiving charging control information necessary for performing control to charge the first battery to and from a second processor (power supply management unit 15) of the electronic device having a second battery and the second processor, the second battery (battery Ba) being charged with the power supplied from the external power supply, the second processor performing control to charge the first battery and the second battery.

Although various embodiments have been described above with reference to the drawings, it is needless to say that the present invention is not limited to such examples. It is obvious that a person skilled in the art can conceive various changes or modifications within the scope described in the claims, and it is naturally understood that such changes or modifications also belong to the technical scope of the present invention. In addition, any combination of constituent elements in the above embodiment may be used without departing from the gist of the invention.

The present application is based on a Japanese patent application filed on Feb. 19, 2020 (JP2020-026412), the contents of which are incorporated herein by reference.

### Explanation of References

1: digital camera
SW1, SW2, SW3, SW4, SW5, SW6, SW7: switch
B1, B2, B3, B4: terminal
L1, L2, L3, L4, L5, L6: communication line
P1, P2: terminal
A1, A2, A3, A4: terminal
2: accessory
11: USB connector
12, 21, 22: charging IC
13: USBPD controller
14: power supply circuit
15: power supply management unit
16: system control unit
23: switching IC
25: accessory control unit
100: camera system

What is claimed is:

1. An electronic device to and from which an accessory is attachable and detachable, the accessory having at least one first battery and a first processor that performs control to charge the at least one first battery, the electronic device comprising:
a connector that is connectable to an external power supply;
a second battery that is charged with electric power supplied from the external power supply;
a power supply circuit by which a power supply voltage is generable from each of the electric power supplied from the external power supply, a voltage of the second battery and a voltage of the first battery; and
a second processor that performs control to charge the at least one first battery, control to charge the second battery, and control to feed electric power from the first battery and the second battery to the power supply circuit,
wherein the second processor has a communication part to communicate with the first processor.

2. The electronic device according to claim 1,
wherein the second processor transmits and receives charging control information necessary for performing control to charge the at least one first battery to and from the first processor via the communication part.

3. The electronic device according to claim 2,
wherein the second processor determines charging power to be supplied to each of the at least one first battery and the second battery based on the electric power supplied from the external power supply, a state of the second battery, and a state of the at least one first battery based on the charging control information received from the communication part, and performs control to charge the at least one first battery and the second battery based on the charging power.

4. The electronic device according to claim 3,
wherein the second processor transmits, to the first processor, information on the charging power to be supplied to the at least one first battery and information for giving an instruction to charge the at least one first battery, as the charging control information, and causes the first processor to perform control to charge the at least one first battery based on the charging control information.

5. The electronic device according to claim 3,
wherein the second processor performs control to supply the electric power supplied from the external power supply to one of the at least one first battery or the second battery in accordance with priority associated with each of the at least one first battery and the second battery, in a state in which there are a plurality of chargeable batteries based on the state of the at least one first battery and the state of the second battery and the electric power supplied from the external power supply is a default value or less.

6. The electronic device according to claim 3,
wherein the second processor performs control to supply the electric power supplied from the external power supply to a chargeable battery based on the state of the at least one first battery and the state of the second battery, among the at least one first battery and the second battery, in a state in which the electric power supplied from the external power supply exceeds a default value.

7. The electronic device according to claim 2,
wherein the second processor receives the charging control information including information indicating whether or not charging is possible for each of the at least one first battery, from the first processor, and transmits the charging control information including information for giving an instruction to start charging for each of the at least one first battery and information on charging power which is used for the charging, to the first processor.

8. The electronic device according to claim 1, further comprising:
an imaging element that is operated by one of the electric power of the external power supply, electric power of the at least one first battery, or electric power of the second battery.

9. An accessory that is attachable to and detachable from an electronic device, the accessory comprising:
at least one first battery; and
a first processor that performs control to charge the at least one first battery,
wherein the electronic device comprises: a connector that is connectable to an external power supply; a second battery that is charged with electric power supplied from the external power supply; a power supply circuit by which a power supply voltage is generable from each of the electric power supplied from the external power supply, a voltage of the second battery and a voltage of the first battery; and a second processor that performs control to charge the at least one first battery, control to charge the second battery, and control to feed electric power from the first battery and the second battery to the power supply circuit, and
the first processor has a communication part to communicate with the second processor.

10. The accessory according to claim 9,
wherein the first processor transmits and receives charging control information necessary for performing control to charge the at least one first battery to and from the second processor via the communication part.

11. The accessory according to claim 10,
wherein the charging control information transmitted by the first processor to the second processor includes information indicating whether or not charging is possible for each of the at least one first battery,
the charging control information received by the first processor from the second processor includes information for giving an instruction to start charging for each of the at least one first battery and information indicating charging power which is used for the charging, and
the first processor performs control to charge the at least one first battery based on the charging control information received from the second processor.

12. The accessory according to claim 9,
wherein the electronic device is an imaging device.

13. A method for operating an electronic device to and from which an accessory is attachable and detachable, the accessory having at least one first battery and a first processor that performs control to charge the at least one first battery, the electronic device having: a connector that is connectable to an external power supply; a second battery that is charged with electric power supplied from the external power supply; and a power supply circuit by which a power supply voltage is generable from each of the electric power supplied from the external power supply, a voltage of the second battery and a voltage of the first battery, the method comprising:
performing, by a second processor of the electronic device, control to feed electric power from the first battery and the second battery to the power supply circuit; and
performing, by the second processor of the electronic device, control to charge the second battery and the at least one first battery by transmitting and receiving charging control information necessary for performing control to charge the at least one first battery to and from the first processor.

14. The method for operating an electronic device according to claim 13,
wherein the second processor determines charging power to be supplied to each of the at least one first battery and the second battery based on the electric power supplied from the external power supply, a state of the second battery, and a state of the at least one first battery based on the charging control information received from the first processor, and performs control to charge the at least one first battery and the second battery based on the charging power.

15. The method for operating an electronic device according to claim 14,
wherein the second processor transmits, to the first processor, information on the charging power to be supplied to the at least one first battery and information for giving an instruction to charge the at least one first battery, as the charging control information, and causes the first processor to perform control to charge the at least one first battery based on the charging control information.

16. The method for operating an electronic device according to claim 14,
wherein the second processor performs control to supply the electric power supplied from the external power supply to one of the at least one first battery or the second battery in accordance with priority associated with each of the at least one first battery and the second battery, in a state in which there are a plurality of chargeable batteries based on the state of the at least one first battery and the state of the second battery and the electric power supplied from the external power supply is a default value or less.

17. The method for operating an electronic device according to claim 14,
wherein the second processor performs control to supply the electric power supplied from the external power supply to a chargeable battery based on the state of the at least one first battery and the state of the second battery, among the at least one first battery and the second battery, in a state in which the electric power supplied from the external power supply exceeds a default value.

18. The method for operating an electronic device according to claim 13,
wherein the second processor receives the charging control information including information indicating whether or not charging is possible for each of the at least one first battery, from the first processor, and transmits the charging control information including information for giving an instruction to start charging for each of the at least one first battery and information on charging power which is used for the charging, to the first processor.

19. The method for operating an electronic device according to claim 13,
wherein the electronic device is provided with an imaging element that is operated by one of the electric power of the external power supply, electric power of the at least one first battery, or electric power of the second battery.

20. A method for operating an accessory that is attachable to and detachable from an electronic device, the accessory having at least one first battery and a first processor that performs control to charge the at least one first battery, the electronic device comprising: a connector that is connectable to an external power supply; a second battery that is charged with electric power supplied from the external power supply; a power supply circuit by which a power supply voltage is generable from each of the electric power supplied from the external power supply, a voltage of the second battery and a voltage of the first battery; and a second processor that performs control to charge the at least one first battery, control to charge the second battery, and control to feed electric power from the first battery and the second battery to the power supply circuit, the method comprising:
transmitting and receiving, by the first processor, charging control information necessary for performing control to charge the at least one first battery to and from the second processor of the electronic device.

21. The method for operating an accessory according to claim 20,
wherein the first processor transmits the charging control information including information indicating whether or not charging is possible for each of the at least one first battery, to the second processor,
the first processor receives the charging control information including information for giving an instruction to start charging for each of the at least one first battery and information indicating charging power which is used for the charging, from the second processor, and
the first processor performs control to charge the at least one first battery based on the charging control information received from the second processor.

22. The method for operating an accessory according to claim 20,
wherein the electronic device is an imaging device.

23. A non-transitory computer readable medium storing a program for operating an electronic device to and from which an accessory is attachable and detachable, the accessory having at least one first battery and a first processor that performs control to charge the at least one first battery, the electronic device having: a connector that is connectable to an external power supply; a second battery that is charged with electric power supplied from the external power supply; and a power supply circuit by which a power supply voltage is generable from each of the electric power supplied from the external power supply, a voltage of the second battery and a voltage of the first battery, the program causing a second processor of the electronic device to execute:
performing control to feed electric power from the first battery and the second battery to the power supply circuit; and
performing control to charge the second battery and the at least one first battery by transmitting and receiving charging control information necessary for performing control to charge the at least one first battery to and from the first processor.

24. A non-transitory computer readable medium storing a program for operating an accessory that is attachable to and detachable from an electronic device, the accessory having at least one first battery and a first processor that performs control to charge the at least one first battery, the electronic device comprising: a connector that is connectable to an external power supply; a second battery that is charged with electric power supplied from the external power supply; a power supply circuit by which a power supply voltage is generable from each of the electric power supplied from the external power supply, a voltage of the second battery and a voltage of the first battery; and a second processor that performs control to charge the at least one first battery, control to charge the second battery, and control to feed electric power from the first battery and the second battery to the power supply circuit, the program causing the first processor to execute:
transmitting and receiving charging control information necessary for performing control to charge the at least one first battery to and from the second processor of the electronic device.
